(19) United States
(12) Patent Application Publication
(10) Pub. No.: US 2017/0313156 A1
(43) Pub. Date: Nov. 2, 2017

(54) HVAC MODULE

(71) Applicant: Valeo Climate Control Corp., Auburn Hills, MI (US)

(72) Inventors: Joseph J. Spryshak, Hartland, MI (US); German Bosherz, Rochester Hills, MI (US); Joe Thompson, Birmingham, MI (US); Steven B. Marshall, Oxford, MI (US); Andrew Eggebroten, Lake Orion, MI (US); Darshan Parikh, Farmington Hills, MI (US)

(21) Appl. No.: 15/584,840

(22) Filed: May 2, 2017

Related U.S. Application Data
(60) Provisional application No. 62/330,814, filed on May 2, 2016.

(51) Int. Cl. B60H 1/00

(52) U.S. Cl. CPC B60H 1/00271; B60H 1/00792; B60H 1/00785; B60H 1/00564; B60H 2001/00214; B60H 2001/003

(57) ABSTRACT

An HVAC module for a vehicle includes a housing having a plurality of airflow paths to guide the air that passes through a cooling unit or a heating unit. An upper discharge outlet temperature is indeterminate based on a temperature of a single temperature sensor in one of the plurality of airflow paths and a blend setting. The HVAC module includes a temperature sensor to determine a reference temperature of the air at a sensor location. The reference temperature is offset from a floor outlet temperature by a floor offset function of the blend setting. The reference temperature is offset from the upper discharge outlet temperature by an upper offset function of the blend setting.

### CROSS-REFERENCE TO RELATED APPLICATION

This application claims the benefit of U.S. provisional application Ser. No. 62/330,814, filed May 2, 2016.

### BACKGROUND

HVAC (Heating Ventilation and Air Conditioning) systems are used for climate control of, e.g., internal cabin areas of an automobile. HVAC systems may be configured with an HVAC module having a heat exchanger disposed in a housing. An HVAC distribution system may be operatively connected to the HVAC module. An HVAC system may have one or more airflow paths for allowing air to flow, for example, to, from, and/or within the HVAC module and the HVAC distribution system. Doors may be associated with the airflow path for controlling the amount of air flowing to, through, and/or from the HVAC module and/or the HVAC distribution system.

### SUMMARY

An HVAC module for a vehicle includes a housing having a plurality of airflow paths to guide the air that passes through a cooling unit or a heating unit. An upper discharge outlet temperature is indeterminate based on a temperature of a single temperature sensor in one of the plurality of airflow paths and a blend setting. The HVAC module includes a temperature sensor to determine a reference temperature of the air at a sensor location. The reference temperature is offset from a floor outlet temperature by a floor offset function of the blend setting. The reference temperature is offset from the upper discharge outlet temperature by an upper offset function of the blend setting.

### BRIEF DESCRIPTION OF THE DRAWINGS

Features of examples of the present disclosure will become apparent by reference to the following detailed description and drawings, in which like reference numerals correspond to the same or similar, though perhaps not identical, components. For the sake of brevity, reference numerals or features having a previously described function may or may not be described in connection with other drawings in which they appear.

FIG. 1 is a graph depicting deviation between sensed temperature and panel average temperature at various blend settings for an existing HVAC module in the bilevel mode;

FIG. 2 is a graph depicting deviation between sensed temperature and defrost average temperature at various blend settings for an existing HVAC module in the mix mode;

FIG. 3 is a graph depicting a deviation between sensed temperature and panel average temperature at various blend settings for an HVAC module in the bilevel mode according to an example of the present disclosure;

FIG. 4 is a graph depicting deviation between sensed temperature and defrost average temperature at various blend settings for an HVAC module in the mix mode according to an example of the present disclosure;

FIG. 5 is a graph depicting an example of a temperature vs. blend setting for an example of the present disclosure;

FIG. 6 is a perspective view of an existing HVAC module depicting a location of an upper temperature sensor and a lower temperature sensor;

FIG. 7A is a schematic diagram depicting mode settings for an HVAC module;

FIG. 7B is a schematic diagram depicting an HVAC module in a vehicle according to an example of the present disclosure;

FIG. 8 is a perspective view of an HVAC module with a sampling manifold and an upper temperature sensor installed in the sampling manifold according to an example of the present disclosure;

FIG. 9 is a right side view of the HVAC module shown in FIG. 8 depicting the sampling manifold and upper temperature sensor installed in the sampling manifold according to an example of the present disclosure;

FIG. 10 is a left side partial interior view of the HVAC module shown in FIG. 9 depicting a defrost airflow sampling aperture, a panel airflow sampling aperture, and a bypass air reinjection aperture according to an example of the present disclosure;

FIG. 11 is a left side perspective cutaway view depicting the HVAC module shown in FIG. 10;

FIG. 12 is a left side view of the sampling manifold shown in FIG. 9;

FIG. 13 is a perspective view of the sampling manifold shown in FIG. 12; and

FIG. 14 is a left side partial interior view of the HVAC module shown in FIG. 10 with the sampling manifold shown in hidden line to show the positional relationship between the sampling manifold and the defrost airflow sampling aperture, the panel airflow sampling aperture, and the bypass air reinjection aperture.

### DETAILED DESCRIPTION

The HVAC module of the present disclosure includes a housing, a blower, a cooling unit, and a heating unit. The cooling unit is to provide cold air and the heating unit is to provide hot air. The heating unit may be a heater core or an electrical heating device. The cooling unit may be an evaporator or an electrical cooling device. These components are typical components for an HVAC module and operate similarly to the components in a conventional HVAC system. Thus, the operation of the blower, cooling unit, and heating unit will not be explained in further detail. Further, any reference to “volume of air” or “airflow” in the specification does not specifically refer to cold air, hot air or mixed air but rather is just a generic term used for simplicity.

Examples of the present disclosure provide for an HVAC system having a temperature sensing device, and a method for estimating discharge temperature at the outlets.

In general, air flows through the heat exchangers of an automotive HVAC module. Air is discharged downstream of the heat exchangers. In examples of the present disclosure, the heat exchangers may be a cooling unit and a heating unit. In examples of the present disclosure, the temperature of the discharged air is determined as disclosed herein, but not measured directly via a temperature sensing device. The temperature sensing device monitors the temperature and sends a signal to a control device.

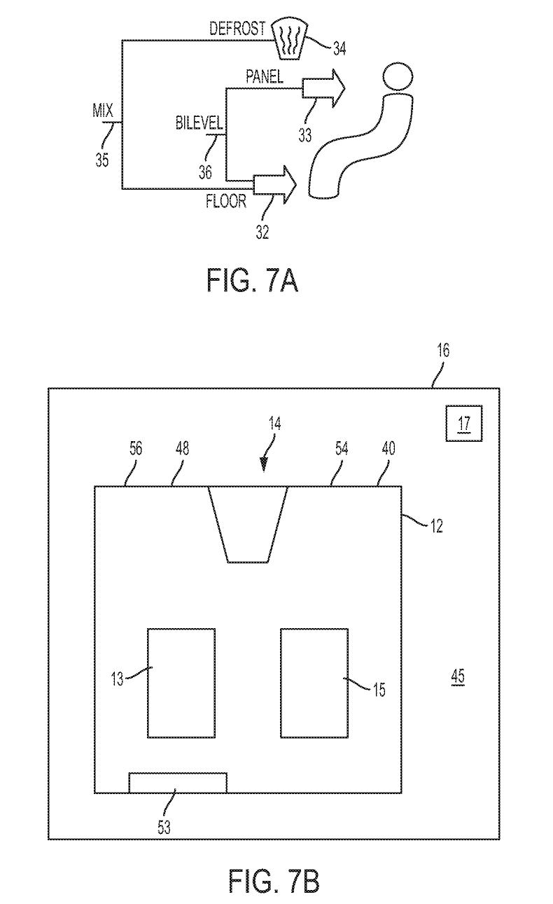

FIG. 7B is a schematic diagram depicting an HVAC module 14 in a vehicle 16 according to an example of the present disclosure. In examples of the present disclosure, an HVAC module 14 for a vehicle 16 includes a housing 12 with a cooling unit 13 and a heating unit 15 disposed therein. The cooling unit 13 is to cool air that passes through the cooling unit 13 and the heating unit 15 is to warm air that passes through the heating unit 15. The heating unit 15 may be a heater core or an electrical heating device. The cooling unit 13 may be an evaporator or an electrical cooling device. The housing 12 has a plurality of airflow paths to guide the air that passes through the cooling unit 13 or the heating unit 15 to a floor outlet 53, an upper discharge outlet or combinations thereof.

In examples of the present disclosure, the upper discharge outlet may be a panel outlet 56, a defrost outlet 54, or combination of the panel outlet 56 and the defrost outlet 54. The defrost outlet 54 discharges air that is ultimately directed into the passenger compartment of the vehicle 16 toward a windshield 17 of the vehicle 16 to defrost or defog the windshield 17. The HVAC module 14 may guide air to the defrost outlet 54 in a defrost mode 34 or a mix mode 35 as depicted in FIG. 7A. The panel outlet 56 discharges air that is ultimately discharged into the passenger compartment of the vehicle 16 from the dashboard or instrument panel toward an upper portion of a first row seat in the vehicle 16. The HVAC module 14 may guide air to the panel outlet 56 in a panel mode 33 or a bilevel mode 36 as depicted in FIG. 7A.

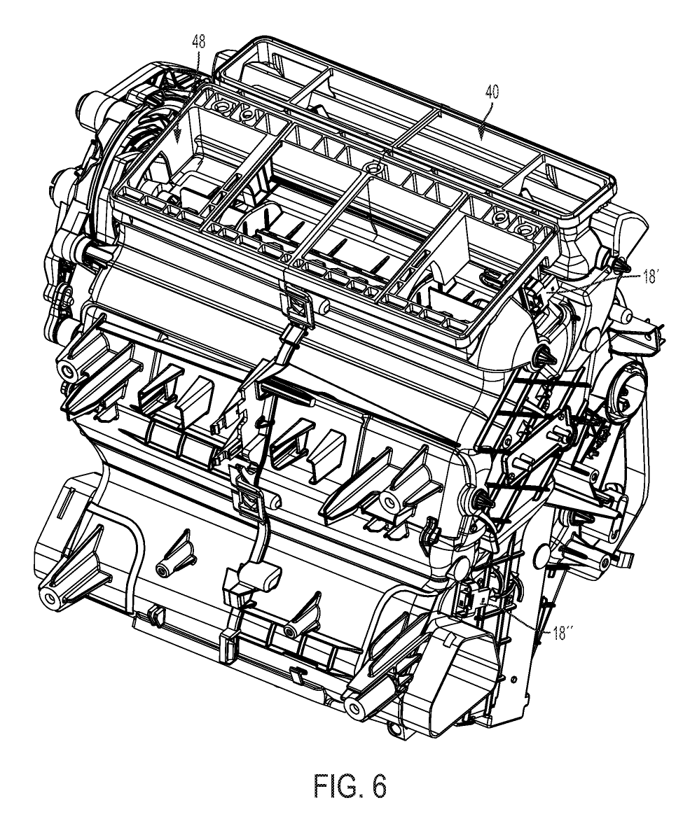

FIG. 6 is a perspective view of an existing HVAC module depicting a location of an upper temperature sensor 18′ and a lower temperature sensor 18″. The upper temperature sensor 18′ and the lower temperature sensor 18″ may be separate instances of similar, if not identical parts. Each temperature sensor 18′, 18″ adds a certain amount of cost to the HVAC module, including the cost of circuits and connectors to process the signals from the temperature sensors.

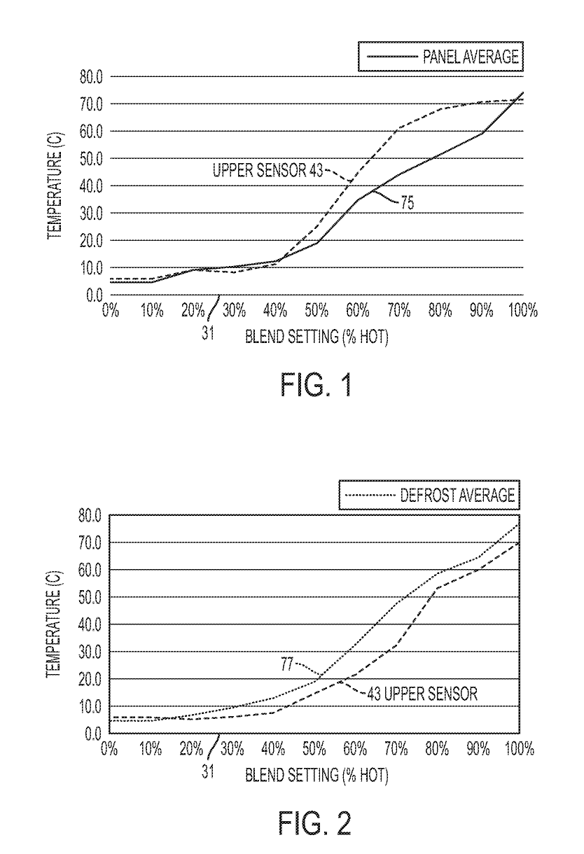

FIG. 1 is a graph depicting deviation between sensed temperature 43 and front panel average temperature 77 at various blend settings 31 for an existing HVAC module in the bilevel mode. FIG. 2 is a graph depicting deviation between sensed temperature 43 and defrost average temperature 75 at various blend settings 31 for an existing HVAC module in the mix mode. FIG. 1 combined with FIG. 2 show that the same offset cannot be used to predict both the front panel average temperature 77 and the defrost average temperature 75 based on the same temperature sensor in different modes. In the bilevel mode (FIG. 1), the offset to the sensed temperature 43 is mainly positive, and in the mix mode (FIG. 2), the offset to the sensed temperature 43 is mainly negative. Applicants have been unable to find any location for a temperature sensor 18 that allows accurate prediction of both the front panel average temperature 77 and the defrost average temperature 75 using a single offset function without also compensating for the mode.

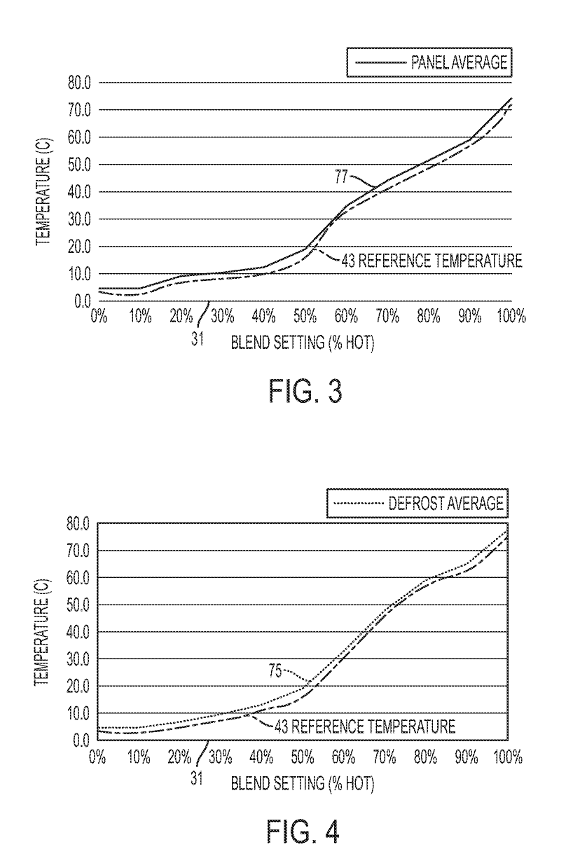

FIG. 3 is a graph depicting a deviation between sensed temperature 43 from mixed air and front panel average temperature 77 at various blend settings 31 for an HVAC module in the bilevel mode according to an example of the present disclosure. FIG. 4 is a graph depicting deviation between sensed temperature 43 from mixed air and defrost average temperature 75 at various blend settings 31 for an HVAC module in the mix mode according to an example of the present disclosure. FIG. 3 and FIG. 4 are actual results from prototype testing/simulation. FIG. 3 and FIG. 4 demonstrate that an offset to the sensed temperature 43 would be mainly positive for both the mix mode (FIG. 4) and the bilevel mode (FIG. 3). It is believed that a single temperature sensor 18 may be used to sense a temperature of mixed air drawn from a plurality of airflow paths, and an offset function of the blend setting 31 can be used to accurately predict both the front panel average temperature 77 and the defrost average temperature 75 that is robust to changes from mode to mode.

In examples of the present disclosure, an upper discharge outlet temperature may be indeterminate based on a temperature of a single temperature sensor 18 in one of the plurality of airflow paths and a blend setting 31. In other examples of the present disclosure, the upper discharge outlet temperature may be indeterminate based on a temperature of a single temperature sensor 18 in one of the plurality of airflow paths and a blend setting combined with a blower setting. As used herein, an indeterminate discharge outlet temperature means that the discharge outlet temperature cannot be accurately determined based on the specified information.

Blend setting is the control setpoint between full cold (i.e., 0% hot) and full hot (i.e., 100% hot). The blend setting may be accomplished via a knob on the instrument control cluster of the vehicle 16. When full heat is desired, the knob is turned to the full heat setting. In some vehicles, the knob is turned fully to the “red” side for full heat. When full cold is desired, the knob is turned to the 0 percent heat setting. In some vehicles, the knob is turned fully to the “blue” side for full cold. In other vehicles, an automatic climate control system may control the blend setting.

In an example of the present disclosure, there is no single location in one of the plurality of airflow paths in which a single temperature sensor can be placed to allow the upper discharge temperature to be determined from a single temperature sensor in one of the plurality of airflow paths by adding or subtracting a predetermined offset temperature for a particular blend setting and/or blower setting. The airflow paths guide the air that passes through the cooling unit and/or the heating unit 15. Hot and cold air is not completely mixed in the airflow paths until reaching the discharge outlets. Therefore, the temperature at any single location in the airflow paths is not an accurate predictor of the temperature in any of the upper discharge outlets. In examples, the upper discharge outlets may be the panel outlet 56 and the defrost outlet 54. The floor outlet 53 may also be a discharge outlet in examples of the present disclosure. Depending on the mode setting, the upper discharge temperature may be the panel outlet temperature and/or the defrost outlet temperature. The mode setting is a mode control setpoint to direct airflow to the floor outlet, a panel outlet, a defrost outlet, or combinations thereof;

FIG. 7A is a schematic diagram depicting mode settings for an HVAC module 14. In examples of the present disclosure, the mode setting may be selectable from a floor mode 32, a panel mode 33, a defrost mode 34, a mix mode 35 and a bilevel mode 36. In the floor mode 32, the HVAC module 14 is to direct airflow through the floor outlet 53. In the panel mode 33, the HVAC module 14 is to direct airflow through the panel outlet 56. In the defrost mode 34, the HVAC module 14 is to direct airflow through the defrost outlet 54. In the mix mode 35, the HVAC module 14 is to direct airflow through the defrost outlet 54 and the floor outlet 53. In the bilevel mode 36, the HVAC module 14 is to direct the airflow through the panel outlet 56 and the floor outlet 53. It is to be understood that in other examples of the present disclosure, there may be other modes, for example to accommodate multi-zone HVAC systems, HVAC systems with ceiling outlets or outlets directed to rear passengers.

In examples of the present disclosure, the defrost outlet 54 discharges air that is ultimately directed into the passenger compartment of the vehicle 16 toward a windshield of the vehicle 16 to defrost or defog the windshield. The panel outlet 56 discharges air that is ultimately discharged into the passenger compartment of the vehicle 16 from the dashboard or instrument panel toward an upper portion of a first row seat in the vehicle 16.

In examples of the present disclosure, there is no single location in the airflow paths between the heat exchangers and the upper discharge outlets that allows simple determination of the panel average discharge temperature and the defrost average discharge temperature. The term panel average discharge temperature is used because the temperature of air discharged from the panel outlet(s) is not exactly the same across the face of the panel outlet(s). For example, the temperature at the left side of an outlet may be different from the temperature at the right side of an outlet. The average temperature of the air across the face of the outlet is a good measure of the cooling/heating effectiveness in the passenger compartment of the vehicle. As used herein, “simple determination” means that there is a predetermined difference between the sensed temperature and the discharge temperature. In other words, if there is simple determination, the discharge temperature may be calculated by adding an offset temperature to the sensed temperature. In examples of the present disclosure, the offset temperature may be a function of the blend setting. In examples of the present disclosure, the offset temperature may also be a function of the blower setting and/or the HVAC mode. For example, the floor offset function may be a function of the blend setting and/or the blower setting. The blower setting is a control setpoint to regulate the amount of airflow from a blower through the HVAC module 14. The upper offset function may be a function of the blend setting and/or the blower setting. The floor offset function may be a function of at least two of the blend setting, a mode setting and a blower setting. The upper offset function may be a function of at least two of the blend setting, the mode setting and the blower setting.

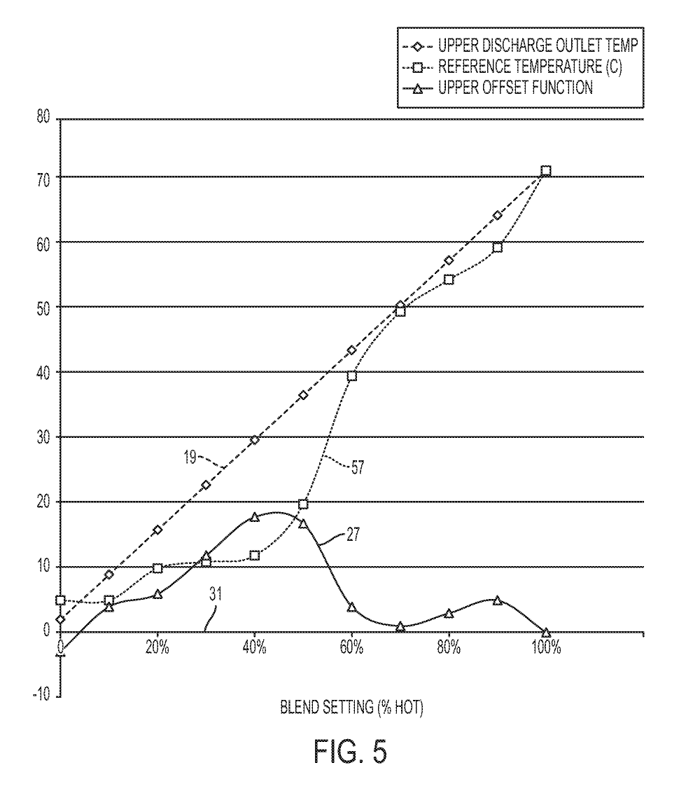

As used in the previous paragraph, the term “function” is used in the mathematical sense. That is, a function is a relation between a set of inputs and a set of permissible outputs with the property that each input is related to exactly one output. In graphs, functions must pass the “vertical line test”: if a vertical line can be drawn anywhere on a graph so that it hits the graph in more than one spot, then the graph is NOT a function. As shown in FIG. 5, the upper offset function 27 added to the reference temperature 19 yields the upper discharge outlet temperature 57. The upper offset function 27 may be calculated, or implemented in a lookup table with, for example, the blend setting 31 as the input.

As an illustration, consider an HVAC system that, unlike examples of the present disclosure, has a front panel average temperature 77 and a defrost average temperature that may be accurately estimated by adding a constant (e.g., 3 degrees) to a sensed temperature 43 from one of the airflow paths. If the blend setting is 60% hot and the sensed temperature 43 is 50 degrees C., and the front panel outlet temperature 77 is 53 degrees C., the front panel outlet temperature 77 may be determined by adding 3 degrees C. to the sensed temperature 43. In the same HVAC system, if the blend setting is 60% hot and the sensed temperature 43 is 82 degrees, then the defrost average temperature 75 would be 82+3=85 degrees C.

However, in examples of the present disclosure, there is no single location in any of the airflow paths in the housing 12 that allows a function of the blend setting to be added to the sensed temperature from that single location to determine the panel outlet temperature and the defrost temperature in all modes that discharge air through the panel outlet or the defrost outlet. Thus, previous HVAC systems would have either accepted the cost of an additional temperature sensor, or accepted inaccurate temperature setting. To illustrate, in a bilevel mode 36 at a blend setting of 50% hot the panel outlet temperature may be offset by +5 degrees from the sensed temperature at a particular location. In the same illustration, in a mix mode 35, with all else the same, the panel outlet temperature may be offset by −3 degrees from the sensed temperature at the particular location in the airflow path. Therefore, in the illustration, there is no function of the blend setting because there are 2 offsets for the same blend setting—the vertical line test is not satisfied.

In the bilevel mode, the HVAC system discharges air through the panel outlet(s) 56 and the floor outlet 53. In the mix mode, the HVAC system discharges air through the defrost outlet(s) 54 and the floor outlet 53. In an existing HVAC system, the temperature at a particular location in the air path may be about 40 degrees C., however, the temperature of the air at the panel outlet 56 may be about 20 degrees C. In the same existing HVAC system in the “mix” mode, the temperature at the particular location in the air path may be about 40 degrees, but the temperature at the defrost outlet may be about 25 degrees C. Thus, if the temperature of the defrost outlet were to be determined using the same reference temperature and offset function as the panel outlet 56, the temperature of the defrost outlet would be determined incorrectly, resulting in an error of about 5 degrees C.

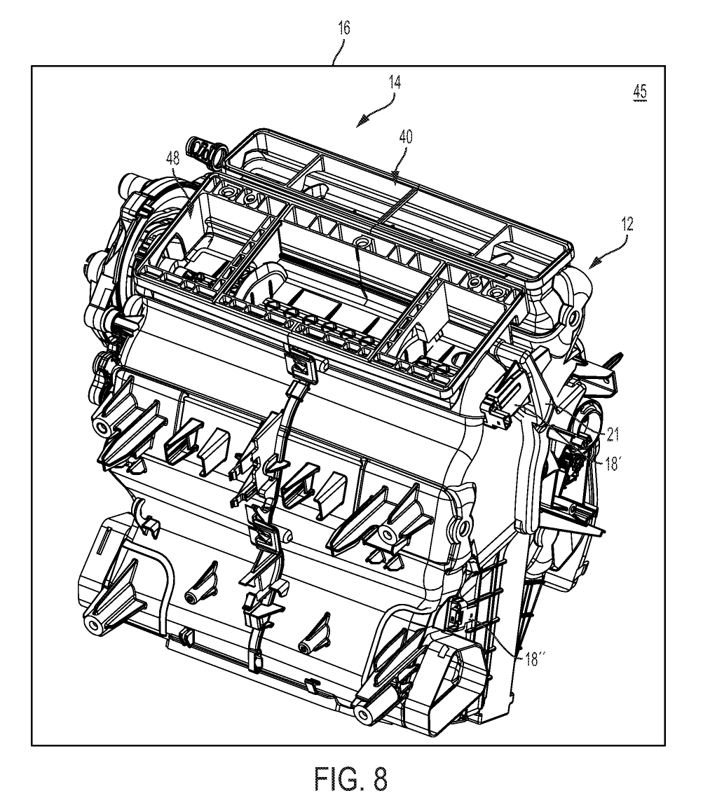

In examples of the present disclosure, the HVAC module 14 includes a temperature sensor 18 to determine a reference temperature of the air at a sensor location with the temperature sensor 18 attached to the housing 12. The sensor location is NOT in one of the plurality of airflow paths of the housing 12 to guide the air that passes through the cooling unit 13 or the heating unit 15 to a floor outlet 53, an upper discharge outlet or combinations thereof. In the example depicted in FIG. 8, the temperature sensor 18 is the upper temperature sensor 18′. The reference temperature may be offset from a floor outlet temperature by a floor offset function of the blend setting. Thus, in the example of the present disclosure in the present paragraph, the lower temperature sensor 18″ may be redundant and may be eliminated. The reference temperature is offset from the upper discharge outlet temperature by an upper offset function of the blend setting.

In examples, the floor offset function may be a function of the mode setting in addition to being a function of the blend setting. In some examples, the floor temperature may be a function of the lower temperature determined by the lower temperature sensor 18″.

Examples of the present disclosure include a method for determining the discharge temperature of the floor, vent and defrost outlets. The method includes determining a reference temperature of the air at a sensor location. The sensor location is NOT in one of the plurality of airflow paths. The method adds a floor offset temperature to the reference temperature to determine the floor outlet temperature. The floor offset temperature is a floor offset function of the blend setting. For example, at a blend setting of 40% hot, the floor offset temperature may be +5 degrees C. At a blend setting of 60% hot, the floor offset temperature might be +10 degrees C. The method also adds an upper offset temperature to the reference temperature to determine the upper discharge outlet temperature. The upper offset temperature is an upper offset function of the blend setting. For example, at a blend setting of 40% hot, the upper offset temperature may be −5 degrees C. At a blend setting of 60% hot, the upper offset temperature might be +3 degrees C.

In examples of the present invention, the HVAC module 14 includes a temperature sensor 18 that may be a thermistor, thermocouple, or other temperature sensing device capable of providing a signal corresponding to a temperature of air at a particular location. A temperature sensing device can be a detector, such as an infra-red sensor or other such device, or sensor, or any device capable of directly or indirectly determining the temperature of the air at the particular location.

FIG. 8 is a perspective view of an HVAC module 14 with a sampling manifold 21 and an upper temperature sensor 18′ installed in the sampling manifold 21 according to an example of the present disclosure. The sampling manifold 21 is NOT one of the plurality of airflow paths of the housing 12 to guide the air that passes through the cooling unit 13 or the heating unit 15 to a floor outlet 53, an upper discharge outlet or combinations thereof.

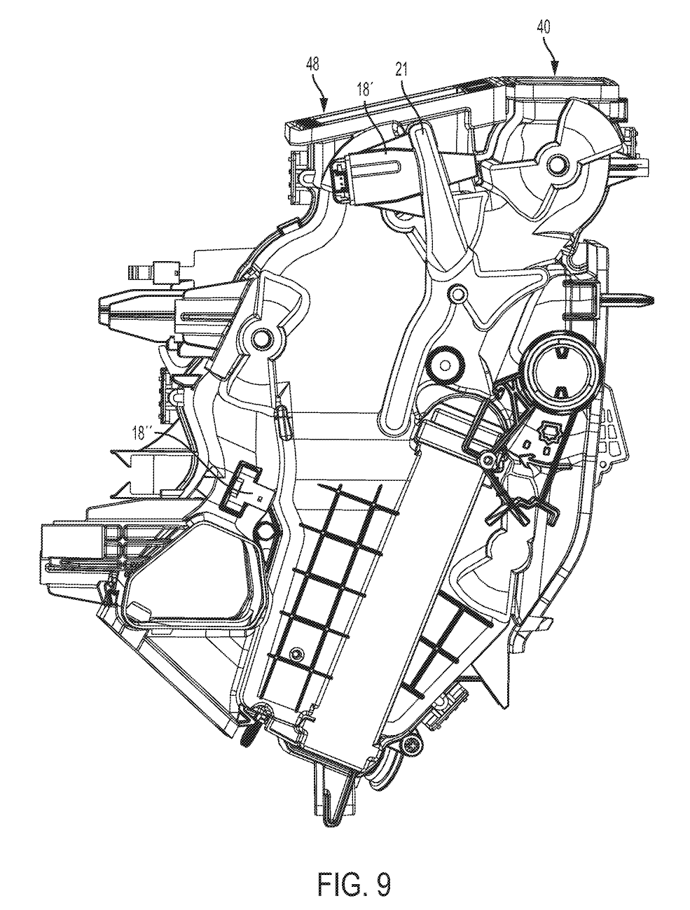

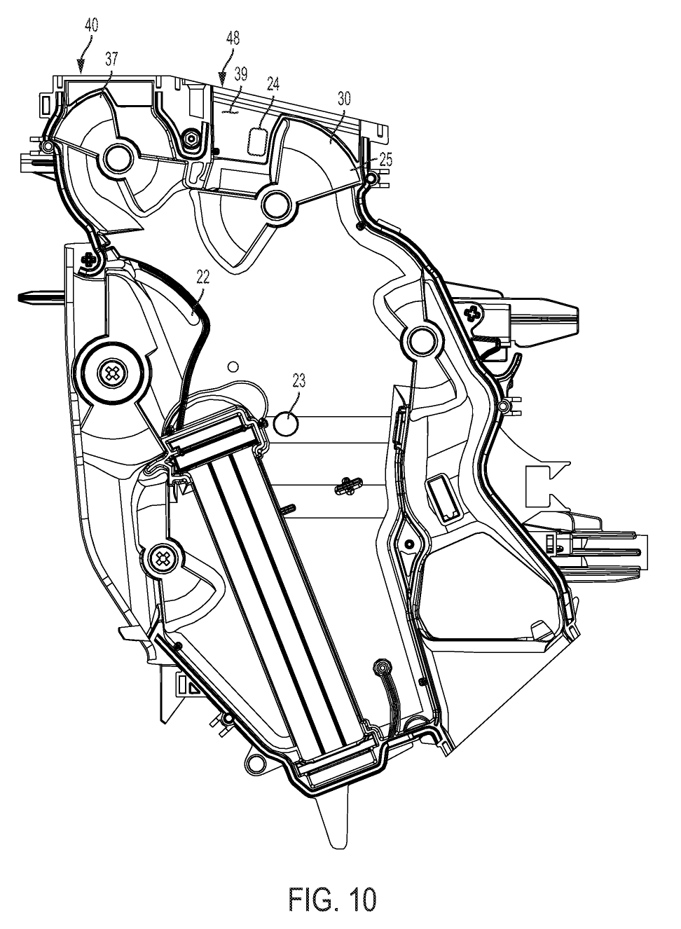

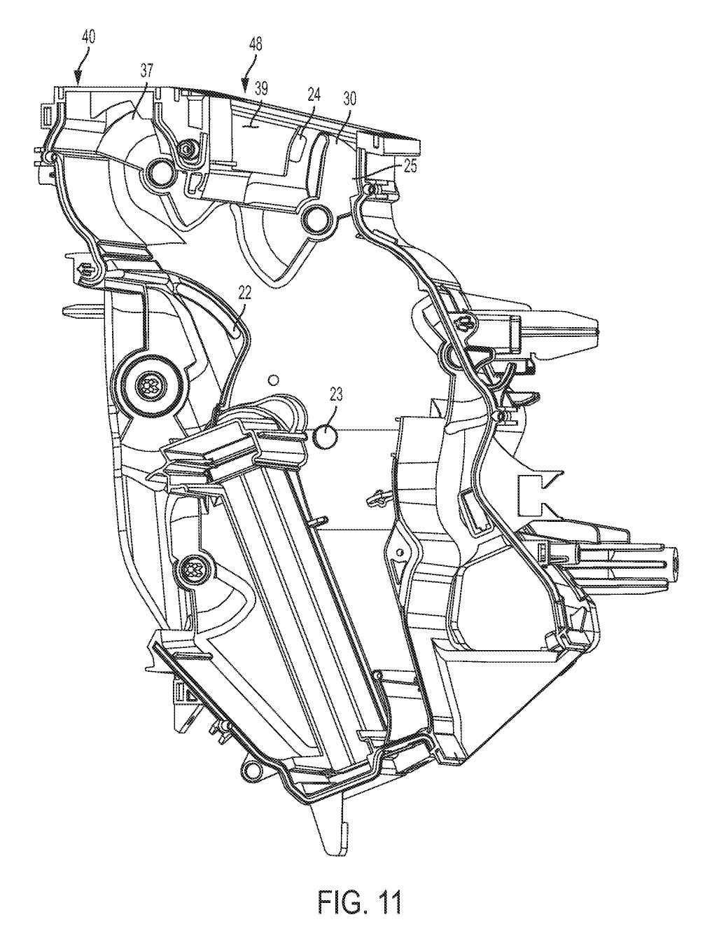

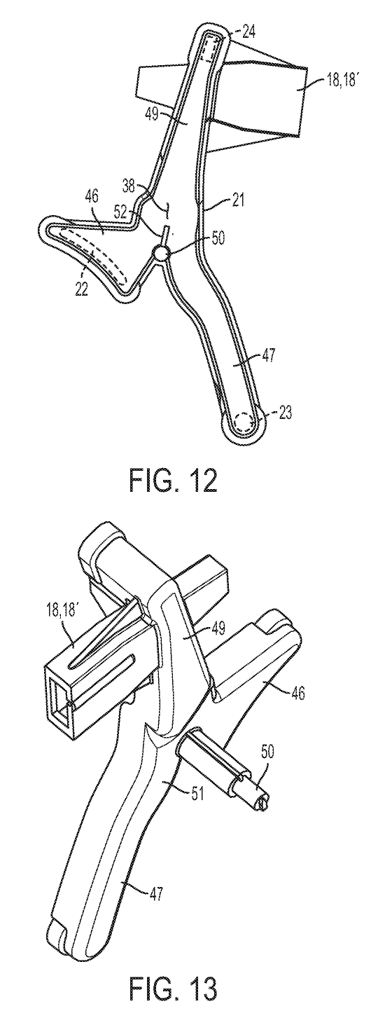

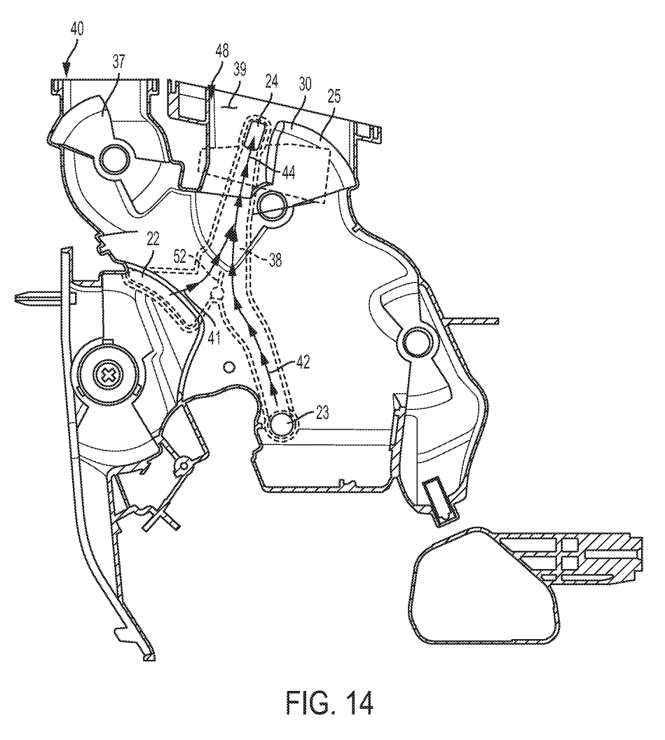

FIG. 9 is a right side view of the HVAC module 14 shown in FIG. 8 depicting the sampling manifold 21 and upper temperature sensor 18′ installed in the sampling manifold 21 according to an example of the present disclosure. FIG. 10 is a left side partial interior view of the HVAC module 14 shown in FIG. 9 depicting a defrost airflow sampling aperture 22, a panel airflow sampling aperture 23, and a bypass air reinjection aperture 24 according to an example of the present disclosure. FIG. 11 is a left side perspective cutaway view depicting the HVAC module 14 shown in FIG. 10. FIG. 12 is a left side view of the sampling manifold 21 shown in FIG. 9. FIG. 13 is a perspective view of the sampling manifold 21 shown in FIG. 12. FIG. 14 is a left side partial interior view of the HVAC module 14 shown in FIG. 10 with the sampling manifold 21 shown in hidden line to show the positional relationship between the sampling manifold 21 and the defrost airflow sampling aperture 22, the panel airflow sampling aperture 23, and the bypass air reinjection aperture 24.

As depicted in FIG. 8, in examples of the present disclosure, the HVAC module 14 includes a defrost airflow path partially defined by a defrost duct 40 defined by the housing 12. The HVAC module 14 also includes a panel airflow path partially defined by a panel duct 48 defined by the housing 12. The HVAC module 14 further includes a sampling manifold 21 disposed on an outside wall 26 of the housing 12 to bypass an airflow baffle 25 defined in the housing 12. The outside wall 26 means an exterior surface opposite an interior surface of the housing 12. The air inside the housing 12 is pressurized when the blower is operating. It is to be understood that the sampling manifold 21 may be defined in the outside wall 26 rather than disposed on the outside wall 26. In examples having the sampling manifold 21 defined in the outside wall 26, suitable walls or baffles may be included to channel the airflow as described in the present disclosure. The sampling manifold 21 simultaneously directs a portion of the airflow from the plurality of airflow paths to a combining chamber 38 inside of the sampling manifold 21. In FIG. 8, the plurality of airflow paths includes the defrost airflow path and the panel airflow path. In examples as depicted in FIG. 8, the reference temperature is a temperature of combined air in the sampling manifold 21. The combined air is reinjected into at least one of the airflow paths downstream of the airflow baffle 25 into a mixing chamber 39 defined in the housing 12. In examples, the mixing chamber 39 may be defined by the defrost duct 40 or the panel duct 48.

In examples of the present disclosure as depicted in FIG. 10, a defrost airflow sampling aperture 22 is defined in the housing 12 to withdraw a portion of the defrost airflow. A panel airflow sampling aperture 23 is defined in the housing 12 to withdraw a portion of the panel airflow. A bypass air reinjection aperture 24 is defined in the housing 12 downstream of the airflow baffle 25. The airflow baffle 25 may be a defrost airflow control baffle 37 or a panel airflow control baffle 30. In the example depicted in FIG. 8 to FIG. 13, the bypass air reinjection aperture 24 is defined in the housing 12 downstream of the panel airflow control baffle 30. In other examples, the bypass air reinjection aperture 24 may be defined in the housing 12 downstream of the defrost airflow control baffle 37.

In examples of the present disclosure as depicted in FIG. 8 to FIG. 11 and FIG. 14, the sampling manifold 21 is attached to the outside wall 26 of the housing 12 to receive the portion of the defrost airflow via the defrost airflow sampling aperture 22. The sampling manifold 21 is further to receive the portion of the panel airflow via the panel airflow sampling aperture 23. As depicted in FIG. 14, the sampling manifold 21 is to combine the portion of the defrost airflow 41 with the portion of the panel airflow 42 in the combining chamber 38 to form the combined air 44, and to channel the combined air 44 to the bypass air reinjection aperture 24 for the reinjection into the mixing chamber 39.

FIG. 12 is a left side view of the sampling manifold 21 shown in FIG. 9. FIG. 13 is perspective view of the sampling manifold 21 shown in FIG. 12. In examples of the present disclosure, a defrost airflow sampling branch 46 is defined in the sampling manifold 21 to receive the portion of the defrost airflow via the defrost airflow sampling aperture 22 and direct the portion of the defrost airflow to the combining chamber 38. A panel airflow sampling branch 47 is defined in the sampling manifold 21 to receive the portion of the panel airflow via the panel airflow sampling aperture and direct the portion of the panel airflow to the combining chamber 38. A reinjection branch 49 is defined in the sampling manifold 21 leading from the combining chamber 38 to the bypass air reinjection aperture 24. The temperature sensor 18 is attached to the reinjection branch 49. The reference temperature is a temperature of the combined air 44 (see FIG. 14) in the reinjection branch 49.

As depicted in FIG. 12 and FIG. 13, examples of the HVAC module 14 of the present disclosure may include a rotatable stem 50 penetrating a sampling manifold wall 51 at an intersection of the defrost airflow sampling branch 46 and the panel airflow sampling branch 47. A mixing flag baffle 52 may be fixedly attached to the rotatable stem 50 for rotation therewith. The mixing flag baffle 52 is adjustable by rotating the rotatable stem 50 to adjust a relative flow rate between the portion of the defrost airflow 41 and the portion of the panel airflow 42.

In examples of the present disclosure, a defrost airflow path is partially defined by a defrost duct 40 defined by the housing 12. A panel airflow path is partially defined by a panel duct 48 defined by the housing 12.

It is to be understood that when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

The terms “connect/connected/connection”, “attach/attached/attachment” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” or “attached to” the other component is somehow in communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

While several examples have been described in detail, it is to be understood that the disclosed examples may be modified. Therefore, the foregoing description is to be considered non-limiting.

What is claimed is:

1. An HVAC module for a vehicle, comprising:
a housing having a plurality of airflow paths to guide air that passes through a cooling unit or a heating unit to a floor outlet, an upper discharge outlet or combinations thereof; and
a temperature sensor to determine a reference temperature of the air at a sensor location wherein:
an upper discharge outlet temperature is indeterminate based on an air temperature of a single temperature sensor in one of the plurality of airflow paths and a blend setting;
the reference temperature is offset from a floor outlet temperature by a floor offset function; and
the reference temperature is offset from the upper discharge outlet temperature by an upper offset function.

2. The HVAC module as defined in claim 1, further comprising:
a defrost airflow path partially defined by a defrost duct defined by the housing;
a panel airflow path partially defined by a panel duct defined by the housing; and
a sampling manifold defined in an outside wall of the housing to bypass an airflow baffle defined in the housing, wherein the sampling manifold simultaneously directs a portion of the air from the plurality of airflow paths to a combining chamber inside of the sampling manifold, wherein the reference temperature is a temperature of combined air in the sampling manifold, and wherein the combined air is reinjected into at least one of the airflow paths downstream of the airflow baffle into a mixing chamber defined in the housing.

3. The HVAC module as defined in claim 1, further comprising:
a defrost airflow path partially defined by a defrost duct defined by the housing;
a panel airflow path partially defined by a panel duct defined by the housing; and
a sampling manifold disposed on an outside wall of the housing to bypass an airflow baffle defined in the housing, wherein the sampling manifold simultaneously directs a portion of the airflow from the plurality of airflow paths to a combining chamber inside of the sampling manifold, wherein the reference temperature is a temperature of combined air in the sampling manifold, and wherein the combined air is reinjected into at least one of the airflow paths downstream of the airflow baffle into a mixing chamber defined in the housing.

4. The HVAC module as defined in claim 3, further comprising:
a defrost airflow sampling aperture defined in the housing to withdraw a portion of a defrost airflow from the defrost airflow path;
a panel airflow sampling aperture defined in the housing to withdraw a portion of a panel airflow from the panel airflow path; and
a bypass air reinjection aperture defined in the housing downstream of the airflow baffle;
wherein the airflow baffle is a defrost airflow control baffle or a panel airflow control baffle;
wherein the mixing chamber is defined by the defrost duct or the panel duct;
and wherein the sampling manifold is attached to the outside wall of the housing to receive the portion of the defrost airflow via the defrost airflow sampling aperture, to receive the portion of the panel airflow via the panel airflow sampling aperture, to combine the portion of the defrost airflow with the portion of the panel airflow in the combining chamber to form the combined air, and to channel the combined air to the bypass air reinjection aperture for reinjection into the mixing chamber.

5. The HVAC module as defined in claim 4, further comprising:
a defrost airflow sampling branch defined in the sampling manifold to receive the portion of the defrost airflow via the defrost airflow sampling aperture and direct the portion of the defrost airflow to the combining chamber;
a panel airflow sampling branch defined in the sampling manifold to receive the portion of the panel airflow via the panel airflow sampling aperture and direct the portion of the panel airflow to the combining chamber; and
a reinjection branch defined in the sampling manifold leading from the combining chamber to the bypass air reinjection aperture, wherein the temperature sensor is attached to the reinjection branch, and wherein the reference temperature is a temperature of the combined air in the reinjection branch.

6. The HVAC module as defined in claim 5, further comprising:
a rotatable stem penetrating a sampling manifold wall at an intersection of the defrost airflow sampling branch and the panel airflow sampling branch; and
a mixing flag baffle fixedly attached to the rotatable stem for rotation therewith, wherein the mixing flag baffle is adjustable by rotating the rotatable stem to adjust a relative flow rate between the portion of the defrost airflow and the portion of the panel airflow.

7. The HVAC module as defined in claim 1 wherein the temperature sensor is a thermocouple, thermistor, or infra-red sensor.

8. The HVAC module as defined in claim 1 wherein:
the upper discharge outlet is a panel outlet, a defrost outlet, or combination of the panel outlet and the panel outlet;
the defrost outlet discharges air that is ultimately directed into a passenger compartment of the vehicle toward a windshield of the vehicle to defrost or defog the windshield; and
the panel outlet discharges air that is ultimately discharged into the passenger compartment of the vehicle from a dashboard or an instrument panel toward an upper portion of a first row seat in the vehicle.

9. The HVAC module as defined in claim 1 wherein:
the floor offset function is a function of the blend setting;
the upper offset function is a function of the blend setting; and
the blend setting is a blend control setpoint between full cold and full hot.

10. The HVAC module as defined in claim 1 wherein:
the floor offset function is a function of a mode setting;
the upper offset function is a function of the mode setting;
the mode setting is a mode control setpoint to direct airflow to the floor outlet, a panel outlet, a defrost outlet, or combinations thereof;
the defrost outlet discharges air that is ultimately directed into a passenger compartment of the vehicle toward a windshield of the vehicle to defrost or defog the windshield; and
the panel outlet discharges air that is ultimately discharged into the passenger compartment of the vehicle from a dashboard or an instrument panel toward an upper portion of a first row seat in the vehicle.

11. The HVAC module as defined in claim 10 wherein:
the mode setting is selectable from a floor mode, a panel mode, a defrost mode, a mix mode and a bilevel mode;
in the floor mode, the HVAC module is to direct airflow through the floor outlet;
in the panel mode, the HVAC module is to direct airflow through the panel outlet;
in the defrost mode, the HVAC module is to direct airflow through the defrost outlet;
in the mix mode, the HVAC module is to direct airflow through the defrost outlet and the floor outlet; and
in the bilevel mode, the HVAC module is to direct the airflow through the panel outlet and the floor outlet.

12. The HVAC module as defined in claim 1 wherein:
the floor offset function is a function of a blower setting;
the upper offset function is a function of the blower setting; and
the blower setting is a control setpoint to regulate the amount of airflow from a blower through the HVAC module.

13. The HVAC module as defined in claim 1 wherein:
the floor offset function is a function of at least two of the blend setting, a mode setting and a blower setting;
the upper offset function is a function of at least two of the blend setting, the mode setting and the blower setting;
the blend setting is a blend control setpoint between full cold and full hot;
the mode setting is a mode control setpoint to direct airflow to the floor outlet, a panel outlet, a defrost outlet, or combinations thereof;
the blower setting is a blower control setpoint to regulate the amount of airflow from a blower through the HVAC module;
the defrost outlet discharges air that is ultimately directed into a passenger compartment of the vehicle toward a windshield of the vehicle to defrost or defog the windshield; and
the panel outlet discharges air that is ultimately discharged into the passenger compartment of the vehicle from a dashboard or an instrument panel toward an upper portion of a first row seat in the vehicle.

14. An HVAC module for a vehicle, comprising:
a housing having a plurality of airflow paths to guide the air that passes through a cooling unit or a heating unit to a floor outlet, an upper discharge outlet or combinations thereof; and
a temperature sensor to determine a reference temperature of the air at a sensor location, wherein:
an upper discharge outlet temperature is indeterminate based on an air temperature of a single temperature sensor in one of the plurality of airflow paths and a blend setting; and
the reference temperature is offset from the upper discharge outlet temperature by an upper offset function.

15. The HVAC module as defined in claim 14, further comprising:
a defrost airflow path partially defined by a defrost duct defined by the housing;
a panel airflow path partially defined by a panel duct defined by the housing; and
a sampling manifold disposed on an outside wall of the housing to bypass an airflow baffle defined in the housing, wherein the sampling manifold simultaneously directs a portion of the air from the plurality of airflow paths to a combining chamber inside of the sampling manifold, wherein the reference temperature is a temperature of combined air in the sampling manifold, and wherein the combined air is reinjected into at least one of the airflow paths downstream of the airflow baffle into a mixing chamber defined in the housing.

16. The HVAC module as defined in claim 15, further comprising:
a defrost airflow sampling aperture defined in the housing to withdraw a portion of a defrost airflow from the defrost airflow path;
a panel airflow sampling aperture defined in the housing to withdraw a portion of a panel airflow from the panel airflow path; and
a bypass air reinjection aperture defined in the housing downstream of the airflow baffle;
wherein the airflow baffle is a defrost airflow control baffle or a panel airflow control baffle;
wherein the mixing chamber is defined by the defrost duct or the panel duct;
and wherein the sampling manifold is attached to the outside wall of the housing to receive the portion of the defrost airflow via the defrost airflow sampling aperture, to receive the portion of the panel airflow via the panel airflow sampling aperture, to combine the portion of the defrost airflow with the portion of the panel airflow in the combining chamber to form the combined air, and to channel the combined air to the bypass air reinjection aperture for reinjection into the mixing chamber.

17. The HVAC module as defined in claim 16, further comprising:
a defrost airflow sampling branch defined in the sampling manifold to receive the portion of the defrost airflow via the defrost airflow sampling aperture and direct the portion of the defrost airflow to the combining chamber;
a panel airflow sampling branch defined in the sampling manifold to receive the portion of the panel airflow via the panel airflow sampling aperture and direct the portion of the panel airflow to the combining chamber; and
a reinjection branch defined in the sampling manifold leading from the combining chamber to the bypass air reinjection aperture, wherein the temperature sensor is attached to the reinjection branch, and wherein the reference temperature is a temperature of the combined air in the reinjection branch.

18. The HVAC module as defined in claim 17, further comprising:
a rotatable stem penetrating a sampling manifold wall at an intersection of the defrost airflow sampling branch and the panel airflow sampling branch; and
a mixing flag baffle fixedly attached to the rotatable stem for rotation therewith, wherein the mixing flag baffle is adjustable by rotating the rotatable stem to adjust a relative flow rate between the portion of the defrost airflow and the portion of the panel airflow.

19. The HVAC module as defined in claim 14 wherein the temperature sensor is a thermocouple, thermistor, or infra-red sensor.

20. The HVAC module as defined in claim 14 wherein:
the upper discharge outlet is a panel outlet, a defrost outlet, or combination of the panel outlet and the defrost outlet;
the defrost outlet discharges air that is ultimately directed into a passenger compartment of the vehicle toward a windshield of the vehicle to defrost or defog the windshield; and
the panel outlet discharges air that is ultimately discharged into the passenger compartment of the vehicle from a dashboard or an instrument panel toward an upper portion of a first row seat in the vehicle.
